(19) United States
(12) Patent Application Publication
(10) Pub. No.: US 2010/0133452 A1
(43) Pub. Date: Jun. 3, 2010

(54) FLUID LEVEL CONTROL VALVE

(75) Inventor: Elias Hajjar, Bankstown (AU)

Correspondence Address: AKIN GUMP STRAUSS HAUER & FELD, LLP, P.O. BOX 130688, DALLAS, TX, 75313-0688, US

(73) Assignee: MICROFLOW INTERNATIONAL PTY LIMITED, (AU)

(21) Appl. No.: 12/445,672

(22) PCT Filed: Oct. 16, 2007
(86) PCT No.: PCT/AU07/01569

§ 371 Date: May 22, 2009

(30) Foreign Application Priority Data
Oct. 16, 2006 (AU) 2006905723

(51) Int. Cl. F16K 31/12

(52) U.S. Cl. 251/12

(57) ABSTRACT

A valve device to control fluid supplied to a tank. The valve device includes a fluid inlet, a fluid outlet to expel fluid to the tank, a valve seat, defining an opening through which fluid is adapted to flow from the inlet to the outlet, a valve member, movable relative to the valve seat between an open position and a closed position, and, a control mechanism to operate said valve device. The control mechanism includes a control chamber, a fluid passageway between the control chamber and the inlet, a flow control element within the fluid passageway, a relief valve, movable between an open position and a closed position to selectively expel fluid from the control chamber to a relief port, and, a relief valve activation mechanism, to control the operation of the relief valve according to an amount of fluid in the tank.

### BACKGROUND OF THE INVENTION

This invention relates to a fluid valve which controls the amount of fluid stored in a tank or reservoir by opening only when the fluid level is below a preset point. The invention particularly relates to a valve which can top up the fluid level in a tank or reservoir, whenever the level is too low, such as in a cistern.

### DESCRIPTION OF THE PRIOR ART

The reference in this specification to any prior publication (or information derived from it), or to any matter which is known, is not, and should not be taken as, an acknowledgement or admission or any form of suggestion that that prior publication (or information derived from it) or known matter forms part of the common general knowledge in the field of endeavour to which this specification relates.

Conventional valves typically have a valve seat and a movable valve member. The movable valve member bears against the valve seat to control the fluid flow. An actuator acts directly on the valve member to cause movement of the valve member. In such conventional valves, the forces required to move the valve member may be quite large.

The Applicant has herebefore designed an improvement to these conventional valves which substantially overcome the drawbacks of the prior art, by providing a valve which is capable of being operated using substantially lower forces than required in conventional type valves. Details of the Applicant's prior art valve device are described in the Applicant's various patents/applications, including International Application No. PCT/AU1996/00263, the disclosures of which should be considered to be entirely incorporated herein by this reference thereto.

In the Applicant's earlier afore-referenced patent application, there is defined a valve device which includes a control chamber, passageways communicating the control chamber with inlet and outlet ports, and, a flow control element within at least one of the passageways. The flow control element effectively controls the flow of fluid within the passageways to thereby control the flow of fluid between the inlet and outlet of the valve device, per se. Utilising this arrangement, only microscopic flows, and minimal power/forces compared with the prior art, are required to control the operation of the valve.

### SUMMARY OF THE INVENTION

The present invention seeks to provide a pressure balanced pilot operated valve incorporating the automatically movable flow control element arrangement described in the afore-mentioned patents/applications.

The present invention seeks to provide a valve device which activates according to the amount of fluid in a tank.

The present invention seeks to provide a valve device which automatically operates according to the pressure, level, volume, or other parameter of fluid in a tank.

In one broad form, the present invention provides a valve device to control fluid supplied to a tank, said valve device including:

a fluid inlet;

a fluid outlet to expel fluid to said tank;

a valve seat, defining an opening through which fluid is adapted to flow from said inlet to said outlet;

a valve member, movable relative to said valve seat between an open and a closed position; and,

a control means to operate said valve device, said control means including:
a control chamber;
a fluid passageway between said control chamber and said inlet;
a flow control element within said fluid passageway;
a relief valve, movable between an open and closed position to selectively expel fluid from said control chamber to a relief port; and,
a relief valve activation means, to control the operation of said relief valve according to the amount of fluid in said tank.

Preferably, said relief valve activation means includes:

a relief chamber, at least partly formed of a movable wall, said movable wall being operatively connected to said relief valve; and,

a fluid path communicating said relief chamber with said tank, such that the pressure within said relief chamber is adapted to be substantially related to the pressure within said tank;

wherein, when the pressure in said tank reaches a predetermined threshold pressure, this is communicated via said fluid path to said relief chamber, causing movement of said movable wall to consequently operate said relief valve and thereby control the operation of said control means to operate said valve device.

Also preferably, said movable wall is in the form of a diaphragm or of like flexible nature.

Preferably, fluid expelled via said relief port is supplied into said tank.

Also preferably, said valve member is in the form of a diaphragm or otherwise formed of flexible material.

Preferably, said flow control element is adapted to move within said passageway to provide self cleaning and flow restriction properties.

Also preferably, the size and/or shape of said passageway and/or said flow control element is selected to control the speed/acceleration of operation of said valve device and/or the power/forces required to operate the valve device.

Preferably, said relief valve activation means is responsive to the pressure, level, volume or other parameters of the fluid in said tank.

Preferably, said device is constructed in a multi-part form, including:

a main body portion, which includes said control chamber; and,

a relief portion, which includes said relief valve.

Also preferably, said main body portion and said relief portion are adapted to be screwed, clipped, snap-fitted or otherwise secured together, optionally in a releasable manner.

In a further broad form, the present invention provides a main body portion of a valve device, the valve device including:

a fluid inlet;

a fluid outlet to expel fluid to said tank;

a valve seat, defining an opening through which fluid is adapted to flow from said inlet to said outlet;

a valve member, movable relative to said valve seat between an open and a closed position; and,

a control means to operate said valve device, said control means including:
a control chamber;
a fluid passageway between said control chamber and said inlet;
a flow control element within said fluid passageway;
a relief valve, movable between an open and closed position to selectively expel fluid from said control chamber to a relief port; and,
a relief valve activation means, to control the operation of said relief valve according to the amount of fluid in said tank;
   characterized in that the main body portion includes said control chamber; and,
   further characterized in that said main body portion is adapted to be attached to a relief portion which includes said relief valve.

Preferably, said main body portion includes:

said control chamber;

said fluid passageway; and,

said flow control element.

In yet a further broad form, the present invention provides a relief portion of a valve device, the valve device including:

a fluid inlet;

a fluid outlet to expel fluid to said tank;

a valve seat, defining an opening through which fluid is adapted to flow from said inlet to said outlet;

a valve member, movable relative to said valve seat between an open and a closed position; and,

a control means to operate said valve device, said control means including:
a control chamber;
a fluid passageway between said control chamber and said inlet;
a flow control element within said fluid passageway;
a relief valve, movable between an open and closed position to selectively expel fluid from said control chamber to a relief port; and,
a relief valve activation means, to control the operation of said relief valve according to the amount of fluid in said tank;
   characterized in that the relief portion includes said relief valve; and,
   further characterized in that said relief portion is adapted to be attached to a main body portion which includes said control chamber.

In yet a further broad form, the present invention provides a method of controlling the flow of fluid supplied to a tank according to a parameter including but not limited to one or more of level, volume, pressure, of fluid in said tank, using a valve device as herein before described.

### BRIEF DESCRIPTION OF THE DRAWINGS

The present invention will become more fully understood from the following detailed description of preferred but non-limiting embodiments thereof, described in connection with the accompanying drawings wherein:

FIG. 1 illustrates a cross-sectional view of a schematic diagram of a valve and its associated components in accordance with the present invention;

FIG. 2 details the valve device in the ‘closed’ position;

FIG. 3 details the valve when ‘activated’, i.e., when the pressure in the tank drops causing a consequential drop of pressure in the relief chamber to open the relief valve;

FIG. 4 details the valve device a short time after the state shown in FIG. 3, wherein the pressure in the control chamber is reduced to consequentially permit movement of the valve member to an open position permitting the flow of fluid from the inlet to the outlet, i.e., when the valve is in the ‘open’ position;

FIG. 5 shows a cross-sectional view of an alternative embodiment of a valve device in accordance with the present invention, wherein the device is constructed in two-part form, that is, having a ‘main body’ portion and a ‘relief’ portion;

FIG. 6 shows the relief portion of the embodiment of FIG. 5;

FIG. 7 shows the main body portion of the embodiment of FIG. 5; and

FIG. 8 shows an alternative arrangement of the main body portion of the embodiment of FIG. 5.

### DETAILED DESCRIPTION OF PREFERRED EMBODIMENTS

Throughout the drawings, like numerals will be used to identify like features except where expressly otherwise indicated.

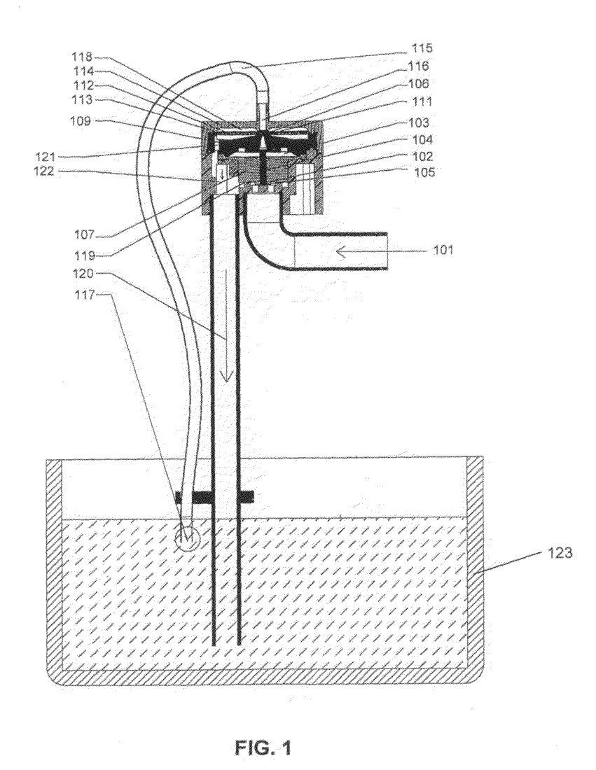

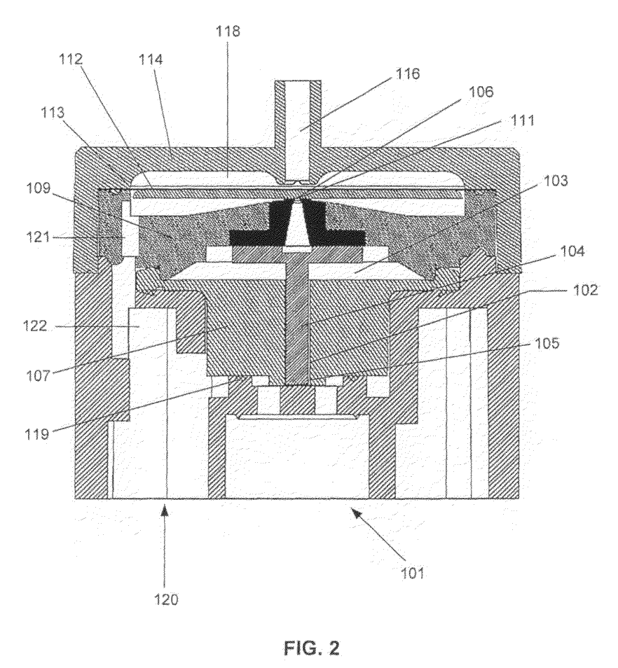

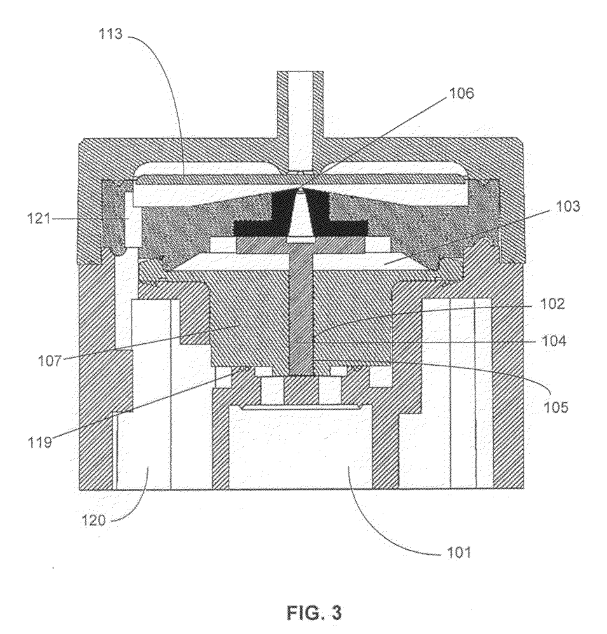

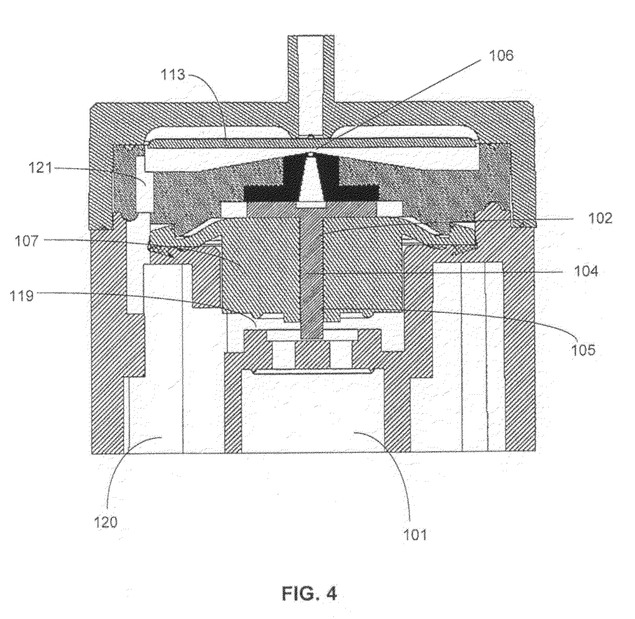

In FIGS. 1 to 4 of the drawings, is shown a first embodiment of a pilot operated valve device of the present invention, incorporating a low powered activation mechanism. FIG. 1 shows the valve device, the inlet, the outlet and a fluid tank connected thereto, FIG. 2 details the valve in its ‘closed’ position, FIG. 3 shows the valve after ‘activation’, and, FIG. 4 shows the valve in its ‘open position’.

The fluid inlet 101 communicates with the control chamber 103 via passageway 102. The passageway 102 is formed within a relatively large orifice 105, partially filled with flow control element 104. The difference in the cross-sectional areas of orifice 105 and flow control element 104 is the actual cross-sectional area of the passageway 102. A control ‘pressure’ chamber 103 is formed by valve body 107, which may be in the form of a diaphragm-like structure, and valve body 109.

Downstream of the passageway 102 is a relief valve 106 formed by orifice 111 and member 112. The relief valve 113, which may also be in the form of a diaphragm, is adapted to push member 112 sealingly against opening 111. The valve body 114 and the relief valve 113 define the relief pressure chamber 118. Opening 116 and tube 115 communicate the relief chamber 118 to a pressure varying environment 117, within a tank or reservoir 123.

Fluid inlet 101 communicates with the fluid outlet 120, when valve member 107 moves away from the valve seat 119, to achieve the ‘open’ position, as shown in FIG. 4. FIG. 3 shows an intermediate ‘activation’ position.

Relief port 121 communicates the control pressure chamber 103 via relief valve 106. Relief port 121 leads to environment 122 where the pressure is lower than that of inlet 101.

FIG. 1 shows the valve in its closed state. That is, the pressure of environment 117 is high enough for relief diaphragm 113 to close relief valve 106. The pressure in chamber 103 is then equal the inlet pressure 101. The difference between the cross-sectional areas of the sides of diaphragm 107 subjected to the inlet pressure, results in forcing diaphragm 107 to seal against valve seat 119 to close the valve.

As shown in FIG. 3, the valve opens when the pressure of environment 117 in tank or reservoir 123 is low enough for relief diaphragm 113 to open relief valve 106, and then fluid is allowed to flow out of pressure chamber 103 through the relatively unrestricted relief valve 106 and relief port 121. The highly restrictive passageway 102 reduces the flow of fluid entering pressure chamber 103 to the extent that its pressure drops to levels that allow valve member or diaphragm 107 to move away from valve seat 119, thereby providing the movement of orifice 105 relative to member 104, and allowing the fluid to flow from inlet 101 to outlet 120, as shown in FIG. 3.

Said arrangement and the automatic movements of the flow control element 104 relative to orifice 105 to form passageway 102, provide, the self-cleaning and the preferred flow restriction properties of passageway 102, and prevent the ingress of particles which otherwise block downstream bypass openings. Particles prevented from entering the control chamber 103 are washed away with the main flow through the relatively large openings of fluid outlet 120.

The valve will remain open, as shown in FIG. 4, until the relief valve 106 is caused/allowed to close as described earlier. Once valve 106 is closed the pressure in chamber 103 rises to force diaphragm 107 towards valve seat 119 thereby closing the valve. The speed at which the valve closes varies directly (but not necessarily proportional) with the flow rate of fluid entering control chamber 103. That is, highly restrictive passageway 102 provides slow shutting speed, therefore, fluid hammering is controlled.

The movement of flow control element 104 relative to orifice 105 whenever the valve is activated can also provide the means for controlling the speed of the shutting and opening speeds (acceleration). One preferred way of achieving this, is by dimensioning the effective flow-path-length of passageway 102 to be varied with said relative movement (as shown by FIG. 1), and/or by introducing variation (eg. tapers) on either or both cross-sections of member 104 and orifice 105. Other methods will become apparent to persons skilled in the art.

The cross-sectional area of the sealing face of orifice 111 is dimensioned so that it is small enough to be closed/opened by small forces and yet large enough not to get clogged by solid particles that are small enough to pass through passageway 102.

Preferably the pressure of environment 117 is related to the fluid level/pressure in the tank or reservoir 123. In this case positioning environment 117 at an appropriate height in the liquid tank 123, as shown in FIG. 1, will determine the parameter, i.e. the fluid level at which the valve shuts.

The self-cleaning and filtering properties of said arrangement along with its feasibility for achieving minute fluid flow rates, made it possible to reliably reduce the cross-sectional areas through which the control fluid flows. Consequently, the response time of this type of pressure balanced pilot operated valves is more controllable and the power/forces required to activate them is relatively smaller.

Now, being able to reliably and favourably, control the response time and reduce the required activation power, does not only eliminate the need for bulky mechanisms (such as lever arms and large floats) and restricted flow rate capacities etc. In fact, it opens the way to using far simpler activation mechanisms and, to having higher flow rates without the fluid hammering problems.

It will be appreciated that the valve device of the present invention therefore provides a valve which controls fluid supplied to a tank. That is, when the pressure, level, or volume of fluid in the tank drops below a certain amount, the valve may be activated to cause fluid flow to thereby increase the supply of fluid in the tank and, when it reaches a prescribed amount, thereby automatically shut off the valve.

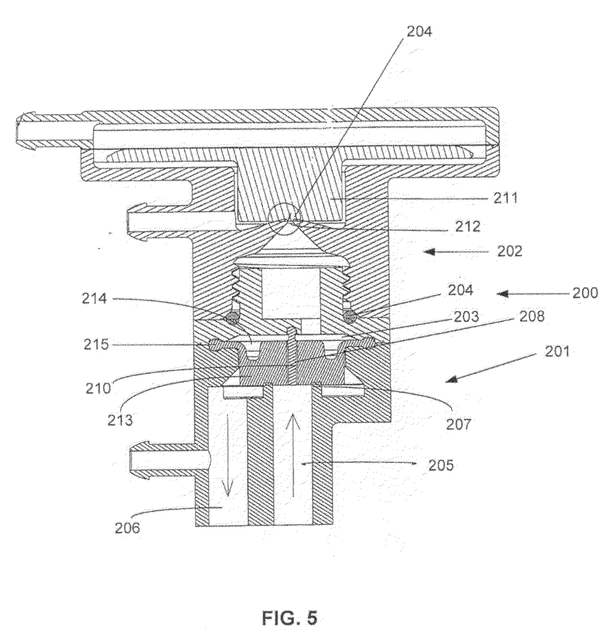

In FIGS. 5 to 8 of the drawings, is shown a second embodiment of a pilot operated valve device of the present invention, incorporating a low powered activation mechanism, but in this embodiment, the valve device 200 is shown to be constructed in a two part form, including a main body portion 201 and a relief portion 202. Whilst such two part construction lends itself to various manufacturing advantages, enabling access to and replacement of various component parts thereof, this two part form will of course be appreciated by persons skilled in the art to be able to be further varied to be constructed in a multi-part form.

The valve device 200 is shown whereby the main body portion 201 includes the control chamber 203, whilst the relief portion includes the relief valve 204. The main body portion 201 and the relief portion 202 may be interconnected in a variety of mariners including, but not limited to screw fitting, clipping, snap-fitting, or otherwise. The embodiment shown is screw fitted, and joined using a sealing ring 204.

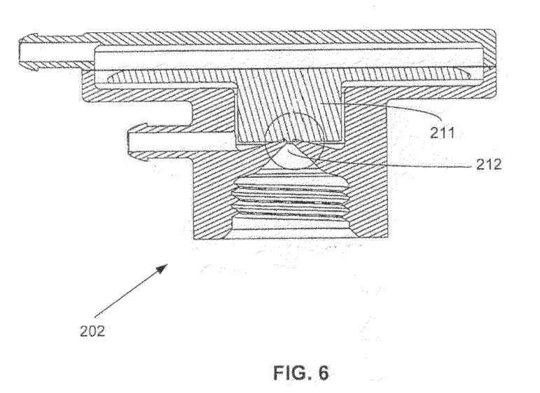

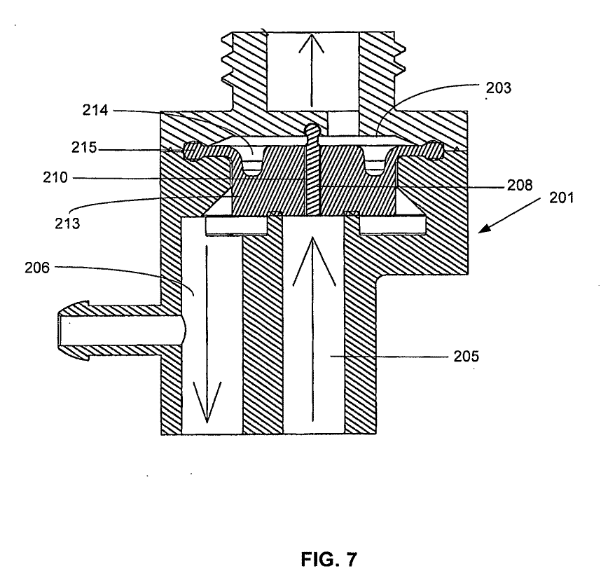

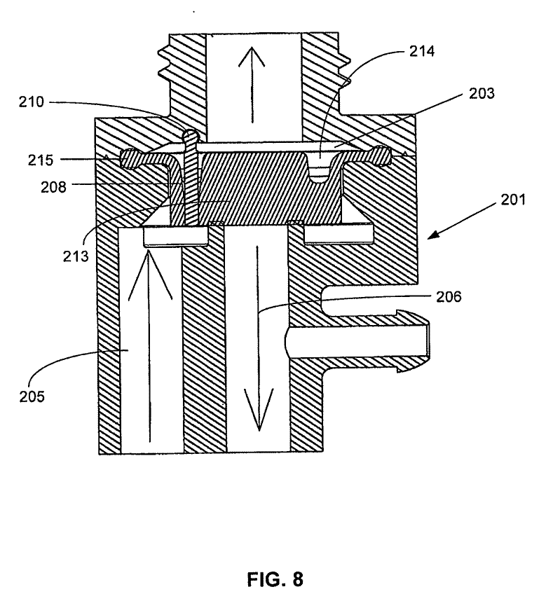

The separate component parts, that is the main body part 201 is shown in FIGS. 7 and 8, whilst the relief part is separately shown in FIG. 6.

In the embodiment shown, the main body part 201 includes the fluid inlet 205, the fluid outlet 206, a valve seat 207 which defines an opening through which fluid can flow from the inlet 205 to the outlet 206, and, a valve component 213, which is movable relative to the valve seat 207 between open and closed positions in the same manner as herein before described with relation to FIGS. 1 to 4. Just as the earlier embodiment, the valve is operated by a control means including the control chamber 203, a fluid passageway 208 between the control chamber 203 and the inlet 205, and, a flow control element 210 which is provided within the fluid passageway.

The relief portion 202, as shown in FIG. 6, includes a relief valve component 211 which is movable between open and closed positions, to selectively expel fluid from the control chamber 203 via the relief port 212. The relief valve 211 is activated to control the operation of the relief valve according to the amount of fluid in a tank or reservoir, just as herein before described with relation to FIGS. 1 to 4.

As shown in FIGS. 7 and 8, the main body portion 201 includes the control chamber 203, the fluid passageway 208 and the flow control element 210. In the case of FIG. 7, the flow control element is provided between the inlet 205 and the control chamber 203 in the centre of the body portion 213, whilst, in the case of FIG. 8, in which the inlet 205 and outlet 206 are swapped in position, the flow control element 210 is provided non-axially through the body 213 to ensure that the flow control element is provided, at least, between the inlet and the control chamber 213.

The flow control element is shown in FIGS. 5, 7 and 8 to be retained within the fluid passageway 208 by having an enlarged end which engages in a correspondingly shaped cutout in the valve member. Likewise, the valve component, which may be constructed of resilient material in the form of a diaphragm-like structure 213 has a main body portion which is substantially cylindrical in shape, a radial recess 214 provided within an upper end surface of the cylindrically shaped body portion 213, and a peripheral flange 215 extending outwardly from the body portion 213 adjacent to the radial recess 214. Further details of the valve component 213 are described in the Applicant's co-pending patent application, the details of which are incorporated entirely herein by this reference thereto.

It will be appreciated that the valve device of the present invention has significant advantages over the prior art, in the amount of power or force which is required to activate/actuate the valve. This is achieved by the combined use of the flow control element in the fluid passageway, which enables microscopic flows to open/close the valve, and, the use of the relief valve in conjunction therewith. It will be understood by persons skilled in the art that the power/forces capable of activating/actuating the valve may be selectively chosen depending upon the characteristics of the flow control element, the fluid passageway, etc.

It will be appreciated that the numerous variations and modifications to the invention will become apparent to person skilled in the art. All such variations and modifications should be considered to fall within the spirit and the scope of the invention as broadly hereinbefore described.

1. A valve device to control fluid supplied to a tank, said valve device including:
a fluid inlet;
a fluid outlet to expel fluid to said tank;
a valve seat, defining an opening through which fluid is adapted to flow from said inlet to said outlet;
a valve member, movable relative to said valve seat between an open and a closed position; and,
a control means to operate said valve device, said control means including:
a control chamber;
a fluid passageway between said control chamber and said inlet;
a flow control element within said fluid passageway;
a relief valve, movable between an open and closed position to selectively expel fluid from said control chamber to a relief port; and,
a relief valve activation means, to control the operation of said relief valve according to the amount of fluid in said tank.

2. A valve device as claimed in claim 1, wherein said relief valve activation means includes:
a relief chamber, at least partly formed of a movable wall, said movable wall being operatively connected to said relief valve; and,
a fluid path communicating said relief chamber with said tank, such that the pressure within said relief chamber is adapted to be substantially related to the pressure within said tank;
wherein, when the pressure in said tank reaches a predetermined threshold pressure, this is communicated via said fluid path to said relief chamber, causing movement of said movable wall to consequently operate said relief valve and thereby control the operation of said control means to operate said valve device.

3. A valve device as claimed in claim 2, wherein said movable wall is in the form of a diaphragm or of like flexible nature.

4. A valve device as claimed in any one of claims 1 to 3, wherein fluid expelled via said relief port is supplied into said tank.

5. A valve device as claimed in any one of claims 1 to 4, wherein said valve member is in the form of a diaphragm or otherwise formed of flexible material.

6. A valve device as claimed in any of the claims 1 to 5, wherein said flow control element is adapted to move within said passageway to provide self cleaning and flow restriction properties.

7. A valve device as claimed in claim 6, wherein the size and/or shape of said passageway and/or said flow control element is selected to control the speed/acceleration of operation of said valve device and/or the power/forces required to operate the valve device.

8. A valve device as claimed in any one of claims 1 to 7, wherein said relief valve activation means is responsive to the pressure, level, volume or other parameters of the fluid in said tank.

9. A valve device as claimed in any one of claims 1 to 8, wherein said device is constructed in a multi-part form, including:
a main body portion, which includes said control chamber; and,
a relief portion, which includes said relief valve.

10. A valve device as claimed in claim 9, wherein said main body portion and said relief portion are adapted to be screwed, clipped, snap-fitted or otherwise secured together, optionally in a releasable manner.

11. A main body portion of a valve device, the valve device including:
a fluid inlet;
a fluid outlet to expel fluid to said tank;
a valve seat, defining an opening through which fluid is adapted to flow from said inlet to said outlet;
a valve member, movable relative to said valve seat between an open and a closed position; and,
a control means to operate said valve device, said control means including:
a control chamber;
a fluid passageway between said control chamber and said inlet;
a flow control element within said fluid passageway;
a relief valve, movable between an open and closed position to selectively expel fluid from said control chamber to a relief port; and,
a relief valve activation means, to control the operation of said relief valve according to the amount of fluid in said tank;
characterized in that the main body portion includes said control chamber; and,
further characterized in that said main body portion is adapted to be attached to a relief portion which includes said relief valve.

12. A main body portion of a valve device, as claimed in claim 11, including:
said control chamber;
said fluid passageway; and,
said flow control element.

13. A relief portion of a valve device, the valve device including:
a fluid inlet;
a fluid outlet to expel fluid to said tank;
a valve seat, defining an opening through which fluid is adapted to flow from said inlet to said outlet;
a valve member, movable relative to said valve seat between an open and a closed position; and,
a control means to operate said valve device, said control means including:
a control chamber;
a fluid passageway between said control chamber and said inlet;
a flow control element within said fluid passageway;
a relief valve, movable between an open and closed position to selectively expel fluid from said control chamber to a relief port; and,
a relief valve activation means, to control the operation of said relief valve according to the amount of fluid in said tank;
characterized in that the relief portion includes said relief valve; and,
further characterized in that said relief portion is adapted to be attached to a main body portion which includes said control chamber.

14. A method of controlling the flow of fluid supplied to a tank according to a parameter, including, but not limited to level, volume, pressure, of fluid in said tank, using a valve device as claimed in any one of claims 1 to 13.

15. A valve device, substantially as herein described with reference to the accompanying drawings.

16. A main body portion of a valve device, substantially as herein described with reference to FIG. 7 or 8 of the accompanying drawings.

17. A relief portion of a valve device, substantially as herein described with reference to FIG. 6 of the accompanying drawings.

18. A method of controlling the flow of fluid supplied to a tank, substantially as herein described.
